(19) United States
(12) Patent Application Publication
(10) Pub. No.: US 2008/0288552 A1
(43) Pub. Date: Nov. 20, 2008

(54) Portable database storage appliance

(76) Inventors: Foster D. Hinshaw, Somerville, MA (US); John Chiu, Lexington, MA (US); Arvind Singh, Arlington, MA (US)

Correspondence Address: GOODWIN PROCTER LLP;PATENT ADMINISTRATOR, EXCHANGE PLACE, BOSTON, MA, 02109-2881, US

(21) Appl. No.: 12/152,379

(22) Filed: May 14, 2008

Related U.S. Application Data
(60) Provisional application No. 60/930,097, filed on May 14, 2007.

(51) Int. Cl. G06F 12/00

(52) U.S. Cl. 707/200; 707/E17.005

(57) ABSTRACT

A data storage system includes an active data store (ADS) and a passive data store (PDS) that, when implemented as a network-attached database appliance, facilitates the separation of operating system software components and data.

### CROSS-REFERENCE TO RELATED APPLICATIONS

This application claims priority to and the benefits of U.S. provisional patent application Ser. No. 60/930,097, filed on May 14, 2007, the entire disclosure of which is incorporated herein by reference.

### FIELD OF THE INVENTION

This invention relates generally to systems for storing computer data, and more specifically to database appliances including disk storage, CPUs, memory and an operating system.

### BACKGROUND

A scalable database appliance consists of a plurality of data servers, each comprising a plurality of disk storage devices, central processing units (CPUs), host-bus adapters (HBAs), memory and an operating system. Traditionally, the disk storage devices of such appliances have contained a mixture of database files, database software, operating system files, operating system software, and other files and software that are not directly used in the functioning of either the database or the operating system.

While convenient, combining functional software with data, and including operating system files with database files on the storage same device, creates inefficiencies while limiting scalability and flexibility. For example, if the operating system software or files are located on the same storage device as the database software or files, performance will suffer as the CPUs on that device must attend to operating system functions instead of being dedicated to data manipulation. If the operating system is to be changed, the device must usually be taken offline (making the contents of the device unavailable) until the operating system change is complete. Furthermore, maintaining operating system software and database software means that any failure of one will likely affect the other. Finally, disk-access patterns for the operating system software and files differs from that of the database software and files, limiting the ability to fully optimize either.

What is needed, therefore, is a database appliance that can function absent the collocation of operating system software and database data and that maintains the database software and files in a manner that optimizes individual access patterns.

### SUMMARY OF THE INVENTION

The invention provides an active data store (ADS) and a passive data store (PDS) that, when implemented as a network-attached database appliance, facilitates the separation of hardware, operating system software components and data. In various embodiments, the ADS is implemented in non-volatile storage and holds operating system files and system management software, as well as configuration information for operational characteristics of the appliance. This management software is desirably self-contained, allowing it to be upgraded independently of the hardware.

In various embodiments, the PDS is a storage device directly attached to the hardware and holds only database management system (“DBMS”) data. Part of the data includes replication-of-configuration information for the operational characteristics of the appliance. The PDS storage technology itself is desirably independent of hardware to which it is connected. In this way, if either the hardware or the ADS component fails, each can be replaced without affecting the other. Upon initial resumption of service, the ADS automatically reconfigures the appliance to function in the operational state and with the characteristics that existed prior to component replacement.

In one aspect of the invention, a database appliance for storing data includes a non-volatile storage configured to store operating system files for operating the database appliance and a physical data store in communication with the non-volatile storage configured to store data notwithstanding the absence of operating system files stored in the physical data store.

The non-volatile storage may include flash memory and/or physical disks, or in some embodiments be implemented as multiple virtual machines. The non-volatile storage may include system management software and configuration information for providing operational instructions to the appliance, and in some implementations may be completely self-contained, allowing it to be upgraded independently from the physical data store in a hardware-independent fashion.

In some embodiments, the physical data store contains replication-of-configuration information for operational characteristics of the appliance, and further may be configured such that the physical data store is independent of hardware to which it is connected, facilitating replacement of the physical data store or the non-volatile storage without affecting the other.

Upon resumption of service following replacement of the physical data store or the non-volatile storage, the non-volatile storage can, in some versions, facilitate automatic reconfiguration of the appliance to function in the operational state and with the characteristics that existed prior to component replacement.

The operating system files on the non-volatile storage may, in some cases, include only statically addressed modules, with all (or some significant number of) legacy drivers and/or video drivers removed. Further, the non-volatile storage is partitioned into a boot partition and a root partition, such that the root partition includes a home directory containing binary and shared library files necessary for operation of the database management system software.

In some implementations, initialization of the non-volatile storage includes booting the appliance from a network, transferring an image of the operating system kernel, the database management software and the configuration files into the non-volatile storage and rebooting the appliance using the non-volatile storage. In some embodiments, rebooting the appliance further comprises identifying a location of and mounting the physical data store.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of relational databases and network attached database storage appliances as configured in accordance with one embodiment of the present invention.

FIG. 2 is a more detailed block diagram of the relational databases and network attached database storage appliances of FIG. 1 as configured in accordance with one embodiment of the present invention.

### DETAILED DESCRIPTION

In general, the invention provides a system and associated techniques for implementing an ADS and PDS within a network-attached storage appliance using non-volatile memory such as compact flash to enable portable or enterprise scale databases of any size, whether they be local or distributed over a network. The ADS maintains operating system functionality that oversees the operation of the device, whereas the PDS is solely responsible for maintaining the DBMS data. Separation of the two functions allows for easier configuration, facilitates optimization of each store according to the functions it provides, and allows each unit to operate independently of the other.

Initially, an operating system kernel (hereafter the “OSK”) is configured in such a manner that it is small enough to fit on the ADS device while maintaining stability. For example, only statically addressed modules need be present on the ADS, whereas legacy drivers and modules can be removed. Furthermore, because there is no need for video support, video drivers may be removed (although in some cases, basic VGA drivers may be retained). Because each device will be communicating with database management software, packages relating to networking protocols (e.g., Samba) are desirably retained, as well as any libraries that may be needed by the database management software. Once configured, the OSK is placed on the ADS device and the device is booted using the OSK. These steps can be repeated (i.e., the removal or addition of various modules, libraries and/or drivers) until a stable OSK is achieved having a sufficiently small footprint. The ADS may then be partitioned into a small boot partition, with the rest of the device storage being allocated to a root partition.

In addition to compiling the operating system software, the database software is also compiled. To do so, any execution prefixes for binaries are set to a static directory to be used as the home install directory on the root partition of the ADS device. In addition, the rpaths for the binaries are set such that they load libraries from the same static directory on the ADS device. Any configuration files for the database are then copied into the home directory. During initialization of the device, the name of the home directory may be provided as a parameter of an initialization script.

For example, to initialize a new appliance, the appliance may be booted off of a network, and the image of the OSK and database binaries and libraries burned onto the ADS device within the appliance. The appliance may then be rebooted using the ADS.

Once booted, the appliance can be configured using scripts or run-time commands. For example, during the first boot of the appliance using the ADS device, the location of the database file space is identified (or, if it does not already exist, it is created). For example, a user may input a directory path (using the Universal Naming Convention, for example), network file system, or local server to be mounted. If the partition does not exist, it is created.

If the directory identified by the user does not contain an initialized database, database initialization software (e.g., the Postgres initdb program in one embodiment) may be run to initialize a database in that location. The directory is then mounted using, for example, network protocol software such as Samba. The permissions are such that a user has the ability to rerun this mount script at anytime. If the database is already initialized, there may be no need to change its configuration. However, if the database is not initialized, a database initialization program (in one embodiment, the Postgres initdb program) is run to create a new configuration file, such as the postgres.conf file in the data directory. This configuration file is then deleted and replaced with a link having the same name that references the configuration file on the ADS device, which can be modified by the user if necessary.

Once the above configuration steps are complete, the database software can be started. In some cases in which the database is an embedded database, the script may fail to mount the database in the user-provided data directory. If so, a small database (e.g., a 1 MB data directory) may be initialized on the ADS device. If the ADS device has a limited number of write cycles (e.g., where the ADS device is embodied in compact flash memory), a warning may be provided to the user that the ADS device has limited write cycles, and writing to the device should be done with caution. If the directory still cannot be mounted, an appropriate error message is provided to the user.

The architecture described above can be used to implement multiple ADS device modules installed on the same motherboard used by the appliance, using either software or hardware virtualization. For software-based virtualization, an appliance is created having a host operating system and virtualization software, and multiple ADS device modules are plugged into the motherboard of the appliance. The virtualization software is started, creating as many instances as the number of ADS device modules, and each one is booted. The steps described above are followed to obtain the location of the data directory, and the database is started in each instance of the virtual machine. In such an implementation, each instance can share the same data directory or they can have separate data spaces that are either local or distributed on the network. Using virtualization software, each ADS operates in, for example, compact flash running off of the same hardware device, but operating with a secure hardware-based “jail.” For hardware-based virtualization, the same process is used as described above except the virtualization capability is built into hardware (e.g., embedded on a physical processor) as opposed to being implemented in software.

The PDS, which is separate and distinct from the ADS, stores both the data and the state of the data (e.g., transaction states) on that blade. For example, while the ADS may be stored in flash memory or on a dedicated physical disk within the blade, whereas the PDS (which may be spread across one or more physical drives) stores only data records. By maintaining physical and logical separation between the ADS and the PDS, drives and blades can be added, removed or moved from one DB host to another without taking the system off-line or needing to reboot.

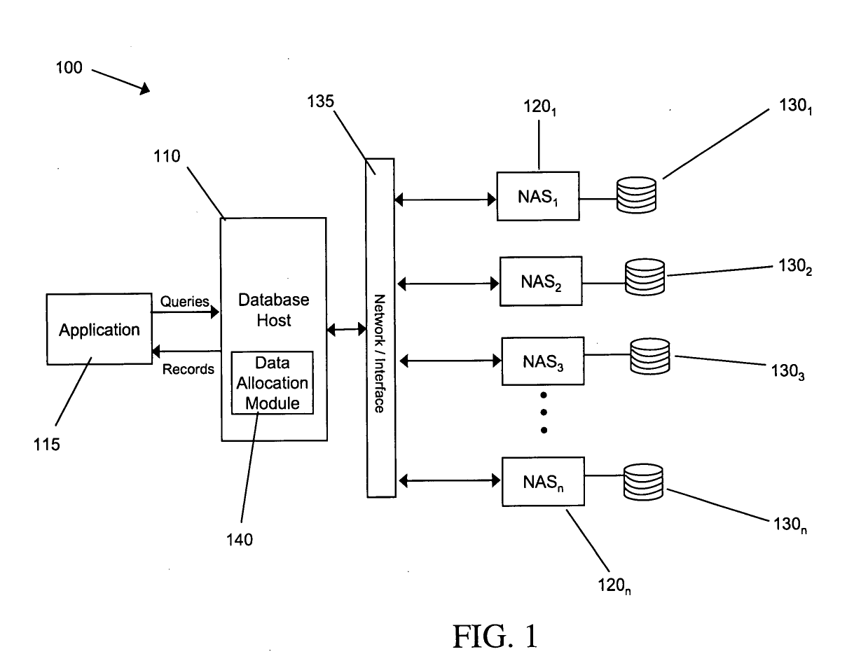

The methods and techniques describe above may be implemented in hardware and/or software and realized as a system for allocating and distributing data among storage devices. For example, the system may be implemented as a data-allocation module within a larger data storage appliance (or series of appliances). Thus, a representative hardware environment in which the present invention may be deployed is illustrated in FIG. 1.

The illustrated system 100 includes a database host 110, which responds to database queries from one or more applications 115 and returns records in response thereto. The application 115 may, for example, run on a client machine that communicates with host I 10 via a computer network, such as the Internet. Alternatively, the application may reside as a running process within host 110.

Host 110 writes database records to and retrieves them from a series of storage devices, illustrated as a series of NAS appliances 120. It should be understood, however, that the term “storage device” encompasses NAS appliances, storage-area network systems utilizing RAID or other multiple-disk systems, simple configurations of multiple physically attachable and removable hard disks or optical drives, etc. In some embodiments, the NAS appliances may also include electrically erasable, programmable read-only memory, such as flash memory or other non-volatile computer memory. As indicated at 125, host 110 communicates with NAS appliances 120 via a computer network or, if the NAS appliances 120 are physically co-located with host 110, via an interface or backplane. Network-based communication may take place using standard file-based protocols such as NFS or SMB/CIFS. Typical examples of suitable networks include a wireless or wired Ethernet-based intranet, a local or wide-area network (LAN or WAN), and/or the Internet.

NAS appliances 1201, 1202 . . . 120n each contain a plurality of hard disk drives 1301, 1302 . . . 130n. The number of disk drives 130 in a NAS appliance 120 may be changed physically, by insertion or removal, or simply by powering up and powering down the drives as capacity requirements change. Similarly, the NAS appliances themselves may be brought online or offline (e.g., powered up or powered down) via commands issued by controller circuitry and software in host 110 or a separately-addressable NAS service module, and may be configured as “blades” that can be joined physically to the network as capacity needs increase. The NAS appliances 120 collectively behave as a single, variable-size storage medium for the entire system 100, meaning that when data is written to the system 100, it is written to a single disk 130 of a single NAS appliance 120.

Host 110 includes a network interface 135 that facilitates interaction with client machines and, in some implementations, with NAS appliances 120. The host 110 typically also includes input/output devices (e.g., a keyboard, a mouse or other position-sensing device, etc.), by means of which a user can interact with the system, and a screen display. The host 110 further includes standard components such as a bidirectional system bus over which the internal components communicate, one or more non-volatile mass storage devices (such hard disks and/or optical storage units), and a main (typically volatile) system memory. The operation of host 100 is directed by its central-processing unit (“CPU”), and the main memory contains instructions that control the operation of the CPU and its interaction with the other hardware components. An operating system directs the execution of low-level, basic system functions such as internal memory allocation, file management and operation of the mass storage devices, while at a higher level, a data allocation module 140 performs the allocation functions described above in connection with data stored on NAS appliances 120, and a storage controller operates NAS appliances 120. Host 110 maintains an allocation table so that, when presented with a data query, it “knows” which NAS appliance 120 to address for the requested data.

Data allocation module 140 may in some cases also include functionality that allows a user to view and/or manipulate the data allocation process. In some embodiments the module may set aside portions of a computer's random access memory to provide control logic that affects the data allocation process described above. In such an embodiment, the program may be written in any one of a number of high-level languages, such as FORTRAN, PASCAL, C, C++, C#, Java, Tcl, or BASIC. Further, the program can be written in a script, macro, or functionality embedded in commercially available software, such as EXCEL or VISUAL BASIC. Additionally, the software could be implemented in an assembly language directed to a microprocessor resident on a computer. For example, the software can be implemented in Intel 80x86 assembly language if it is configured to run on an IBM PC or PC clone. The software may be embedded on an article of manufacture including, but not limited to, “computer-readable program means” such as a floppy disk, a hard disk, an optical disk, a magnetic tape, a PROM, an EPROM, or CD-ROM.

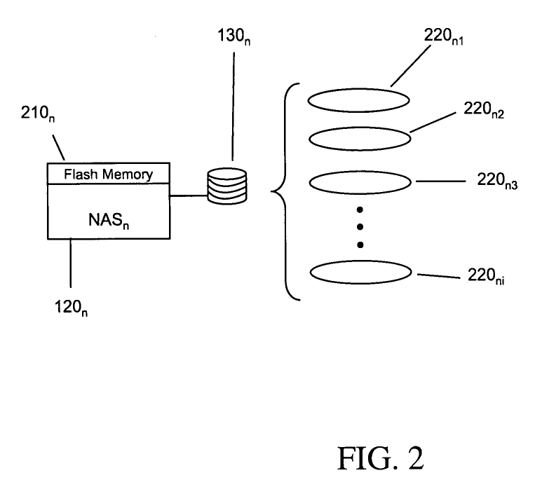

Referring to FIG. 2, the appliance may include flash memory 210 as a storage medium for the ADS. In such cases, the disk stack 130 within appliance 120 (which typically will include multiple physical disks 220) is allocated solely to the PDS. In some embodiments, one (or in some cases more than one) disk may be dedicated to storing the files allocated to the ADS (e.g., the operating system kernel and any database management services) and the remaining disks are used for the PDS. In this manner, individual disks (including, for example, the disk containing the OS kernel) may be swapped without having to reinitialize the NAS or even notify the host.

Variations, modifications, and other implementations of what is described herein will occur to those of ordinary skill in the art without departing from the spirit and the scope of the invention as claimed.

1. A database appliance for storing data, the appliance comprising:
a non-volatile storage configured to store operating system files for operating the database appliance, database management system software, and configuration files for access data; and
a physical data store in communication with the non-volatile storage, the physical data store being configured to store data notwithstanding the absence of operating system files stored thereon.

2. The database appliance of claim 1 wherein the non-volatile storage comprises flash memory.

3. The database appliance of claim 1 wherein the non-volatile storage comprises physical disks.

4. The database appliance of claim 1 comprising a plurality of the non-volatile storages, each implemented in one of a plurality of virtual machines.

5. The database appliance of claim 4 wherein the physical data store is shared by the plurality of non-volatile storages.

6. The database appliance of claim 1 wherein the system management software is self-contained, allowing it to be upgraded independently in a hardware-independent fashion.

7. The database appliance of claim 1 wherein the physical data store contains replication-of-configuration information for operational characteristics of the appliance.

8. The database appliance of claim 1 wherein the physical data store is independent of hardware to which it is connected, facilitating replacement of the physical data store or the non-volatile storage without affecting the other.

9. The database appliance of claim 8 wherein, upon resumption of service following replacement of the physical data store or the non-volatile storage, the non-volatile storage facilitates automatic reconfiguration of the appliance to function in the operational state and with the characteristics that existed prior to component replacement.

10. The database appliance of claim 1 wherein the operating system files comprise only statically addressed modules.

11. The database appliance of claim 1 wherein the operating system files are devoid of legacy drives and video drivers.

12. The database appliance of claim 1 wherein the non-volatile storage is partitioned into a boot partition and a root partition

13. The database appliance of claim 12 further comprising a home directory located within the root partition and containing binary and shared library files necessary for operation of the database management system software.

14. The database appliance of claim 1 in which the non-volatile storage is initialized by performing the following steps:
(i) booting the appliance from a network;
(ii) transferring an image of the operating system kernel, the database management software and the configuration files into the non-volatile storage; and
(iii) rebooting the appliance using the non-volatile storage.

15. The database appliance of claim 14 in which the step of rebooting the appliance further comprises the steps of (a) identifying a location of the physical data store, and (b) mounting the physical data store.
